(19) United States
(12) Patent Application Publication
(10) Pub. No.: US 2013/0254259 A1
(43) Pub. Date: Sep. 26, 2013

(54) METHOD AND SYSTEM FOR PUBLICATION AND SHARING OF FILES VIA THE INTERNET

(71) Applicant: Brett J. Wilson, Melbourne (AU)

(72) Inventor: Brett J. Wilson, Melbourne (AU)

(73) Assignee: FAST TRACK TECHNOLOGIES LIMITED, Lyford Cay (BS)

(21) Appl. No.: 13/424,593

(22) Filed: Mar. 20, 2012

(51) Int. Cl. G06F 15/16

(52) U.S. Cl. 709/203

(57) ABSTRACT

A method and system of publishing and sharing files over the internet wherein one or more files are uploaded from a software application on a client device to a web server which generates a URL location for the file(s) and an associated text message that are transmitted back to the client device for sharing with third-party devices at the same time the file(s) continue to upload on the web server in the background.

### FIELD OF THE INVENTION

This invention relates to a method and system of publishing and sharing files via the internet, and, more particularly, to a method and system wherein one or more files are uploaded from a software application on a client device to a web server which substantially immediately generates a uniform resource locator (URL) location for the file(s) that is transmitted back to the client device. The URL location may then be transmitted from the client device, while the file(s) continue to upload on the web server in the background, in such a way as to allow third-party devices to access the file(s) on the web server.

### BACKGROUND OF THE INVENTION

Internet usage has increased dramatically in recent years with the sophistication of smart-phones and tablet computers in addition to traditional desktop and note book computers. In many ways, the internet-using public suffers from productivity delays caused by ineffective technology solutions that require undue time and effort in order to accomplish online tasks. Effective communication, audience engagement, file sharing and publishing on remotely connected devices over the internet using current methods are often seriously lacking in usability, functionality and time effectiveness.

Presently, the publishing or sharing of any file types and their related text descriptions over the internet is typically a lengthy and cumbersome process, often involving numerous steps, and, in some cases, multiple software applications. For example, in one commercially available process and method an initial screen appears on one's smart phone or other device requesting the user to choose a file such as a photo or video from the memory of the device, or employ the camera of the device to take a photo. By way of example, and depending on internet speeds and device capabilities, if a 20 second video is selected for publication it first must be compressed, e.g. the device creates a compressed version of the video suitable for web publishing. This process may take up to about 30 seconds for a 20 second video. A screen is then provided to the user allowing he or she to initiate uploading of the compressed version of the video, which, in the example of a 20 second video, takes about 2-3 minutes. When uploading has been completed, another screen is presented to the user with options on sharing the file, such as via e-mail, a social networking site like “Twitter” and others. During the entire process of file selection, file compression, uploading and sharing, which may take about 4 minutes or longer in the case of a 20 second video, the user must monitor the progress of each step in the process in order to proceed to the next step. This is extremely inefficient and a waste of valuable time, particularly for users wishing to send a high volume of publications to third parties from the same device.

### SUMMARY OF THE INVENTION

This invention is directed to a method and system of publishing and sharing files over the internet wherein one or more files are uploaded from a software application on a client device to a web server which generates a URL location for the file(s) that is transmitted back to the client device. The URL location may then be transmitted from the client device, while the file(s) continue to upload on the web server in the background, in such a way as to allow third-party devices to access the file(s) on the web server.

In the presently preferred embodiment, the software application of this invention is downloaded to the client device from the web server or other server via the interne. The software application may be employed to create a new file, or select one or more existing files stored on the client device, which are then uploaded to the web server creating a publication, optionally with a privacy setting selected by the user. In response, the web server creates a URL location and a displayable web page containing the file(s) which is easy to interact with, view and display. The web server transmits the URL location to the software application on the client device, preferably accompanied by a text message created by the web server that may be modified at the option of the user. Generation of the URL location and text message, and transmission of same to the client device, occurs substantially immediately following commencement of uploading the file(s) to the web server from the software application on the client device.

Upon receipt of the URL location and associated text message from the web server, the user may immediately begin sharing the URL location of the file(s), and creating a description of the file(s) published to the web page, while they are still being background uploaded to the web server. In one embodiment, the URL location and text message may be copied to a clipboard function on the client device and then pasted into any application supported by the client device capable of sharing with third party devices. Alternatively, the URL location and text message may be transmitted from the client device to third-party devices via e-mail or using one of a number of publically accessible sites such as a web site, bookmarking site, social networking site, blogging site etc. In either case, third parties may employ the URL location to link to the web page created on the web server where they may access the file(s) that the user has, or is in the process of, uploading to the web server as a web publication.

The ability to publish and share web-based publications with others nearly instantaneously following initiating the uploading of file(s) to the web server allows the user of the software application to proceed with other tasks rather than waiting around until all processes are completed. For example, after initiating the upload of one created file, or one or more existing files, the user may proceed with the creation or selection of additional files for publication to the same URL location as the initial file(s). Further, the description of the published file(s), the content of the text message accompanying the URL location, and, the privacy setting selected for the publication, may be changed at any stage during the process or deleted before a “finish” button is activated. All of these tasks may be performed “on the fly,” e.g. in real time, provided the client device remains connected to the internet and while the initial file(s), and any subsequent files, are being uploaded in the background to the web server. Accordingly, the method of this invention greatly increases the productivity of the user and enhances the functionality and time-effectiveness of the client device.

### DESCRIPTION OF THE DRAWINGS

The structure, operation and advantages of the presently preferred embodiment of this invention will become further apparent upon consideration of the following description, taken in conjunction with the accompanying drawings, wherein:

FIG. 1 is a schematic block diagram of the overall configuration of the system employed in the method of this invention;

FIG. 2 is a schematic block diagram relating to the creation or selection of files for uploading to the web server;

FIG. 3 is a schematic block diagram of the interaction between the web server and software application on the client device; and

FIG. 4 is a schematic block diagram of the step for sharing files with third parties.

### DETAILED DESCRIPTION OF THE PREFERRED EMBODIMENT

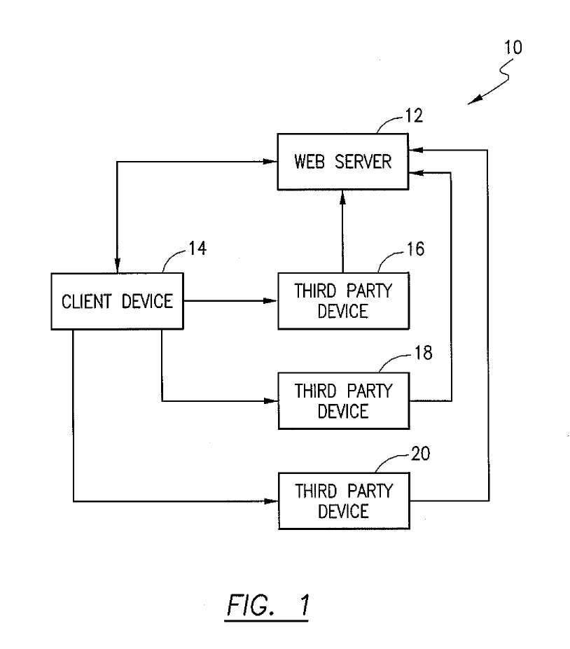

Referring now to the drawings, the system 10 of this invention is schematically illustrated in FIG. 1. The system 10 includes a web server 12 that may be connected via the internet to a client device 14. The client device 14 may be a desktop computer, a notebook computer, a laptop computer, a smart phone, a tablet computer or essentially any other device that may be connected to the internet. The third party devices 16, 18 and 20 depicted in FIG. 1 may be the same type of device as the client device 14, and each may be connected to the web server 10 and to the client device 14 by the internet. For purposes of the following discussion, a “connection” to the internet is meant to encompass any present or future means of connection such as cable, telephone lines, wireless and the like. Three third party devices 16-20 are shown in FIG. 1 for purposes of illustration only, it being understood that any number of third party devices may be employed in the system and method of this invention. The interaction of the components shown in FIG. 1 is described below in connection with a discussion of the method of this invention.

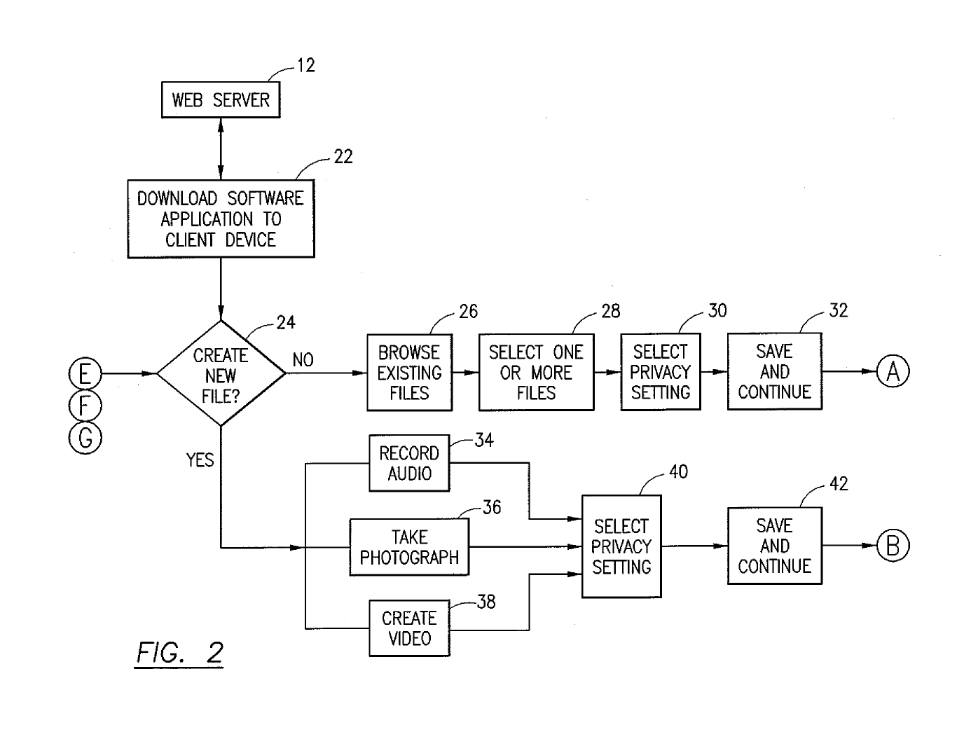

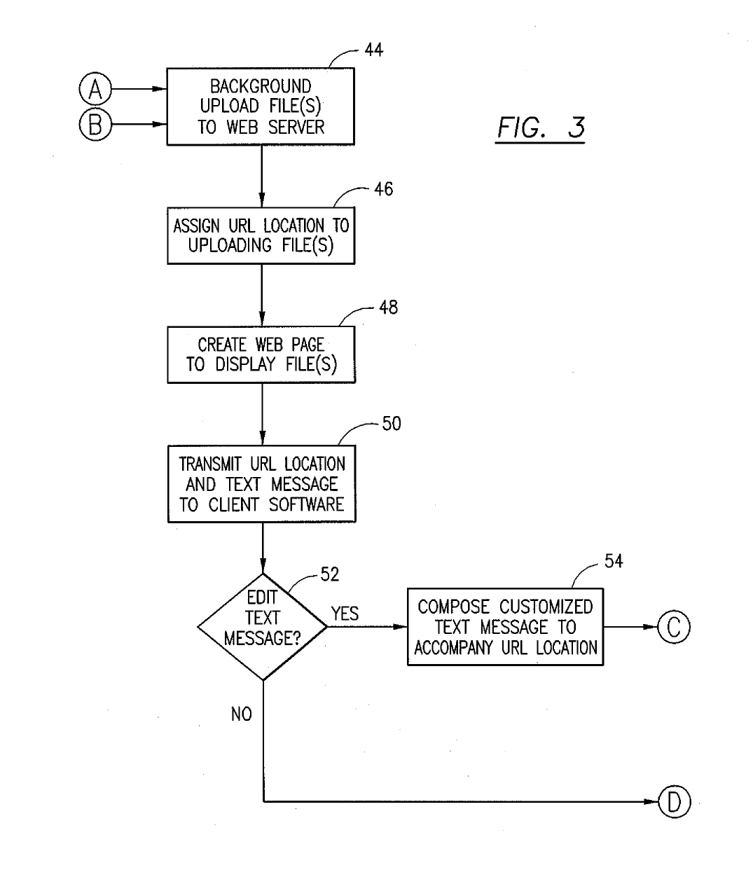

Initially, it is contemplated that the user of a client device 14 may be provided with a link to the web server 12, or to another web site, where he or she may download the software application of this invention to the client device 14. See box 22. Once the software application is available on the client device 14, the user may open the software and view a screen that presents the options of creating a new file or selecting an existing file or files, as represented by box 24 in FIG. 2. In the event the user declines to create a new file, he or she may browse existing files stored on the client device (box 26) and then select one or more files for publication to the web server 12, as discussed in detail below. See box 28. Once one or more files are selected by the user, he or she may decide on a privacy setting for such file(s), as represented by box 30 in FIG. 2. Details of the privacy settings available with the software application of this invention are described below in connection with a discussion of the method steps denoted in FIG. 3. After a privacy setting has been selected by the user, he or she may click on a “save and continue” button displayed on the screen provided by the software application at this stage of the process. See box 32. For purposes of the present discussion, the term “save” noted in regard to box 32 refers to the instantaneous capability of the software application of this invention to store a created file and, one or more selected files, as well as privacy settings, for transmission to the web server 12.

Alternatively, the user may chose to create a new file for his or her publication as schematically represented at the bottom portion of FIG. 2. Depending on what is permitted by the existing functionality of a given client device 14, various files may be created using the software application of this invention such as an audio recording represented by box 34, a photograph denoted by box 36, a video recording referenced by box 38, and/or combinations thereof, e.g. a photograph plus an audio recording, for example. It should be understood that the created files represented by boxes 34-38 are for purposes of illustration only and other files may be created including those containing text, data and the like. Additionally, it is contemplated that a single created file would be the subject of a publication to the web server 12, in the manner described below, since as a practical matter only one audio recording, photo or video may be created by a client device 14 at a time. A privacy setting may be selected after the file is created, as at box 40, followed by clicking a save and continue button displayed on the screen provided by the software application. See box 42.

Referring now to FIG. 3, once one of the save and continue buttons is clicked, as represented by boxes 32 and 42 of FIG. 2, the file(s) that have either been selected or created in the previous steps are background uploaded to the web server 12. See box 44. The term “background upload” or “background uploading” as used herein is meant to refer to the transmission of one or more files from the software application on the client device 14 to the web server 12 which is capable of proceeding at the same time that other tasks are being performed on the client device 14, either using the software application of this invention or other functionality of the client device 14. As soon as a file(s) begins uploading to the web server 14, it assigns a URL location to the file(s) as represented by box 46 and creates a web page, linked to the assigned URL location, to display the file(s). See box 48. In the presently preferred embodiment, the web server 14 may also creates a generic text message that may be associated with the URL location, such as, for example, “please view/play/listen to this/these files and view their related descriptions by clicking on this link: http://website.com/xyz.”

Depending on internet speeds and the capabilities of a particular client device 14, large audio, video and other files may take some time to upload from the software application on the client device 14 to the web server 12. Unlike prior art methods and systems for sharing files via the internet, the present invention allows the user to avoid time-consuming and inefficient delays involved in the uploading and sharing process. Substantially immediately after the web server 12 creates the URL location at box 46, and preferably a generic text message as noted above, it transmits them to the client software 14 via the internet as represented by box 50 in FIG. 3. The user is given the option of editing the text message, as at box 52, and, if desired, may compose his or her own customized message for sharing with third parties. See box 54. Editing of the text message may proceed while the file(s) continue to be uploaded to the web server 12 in the background.

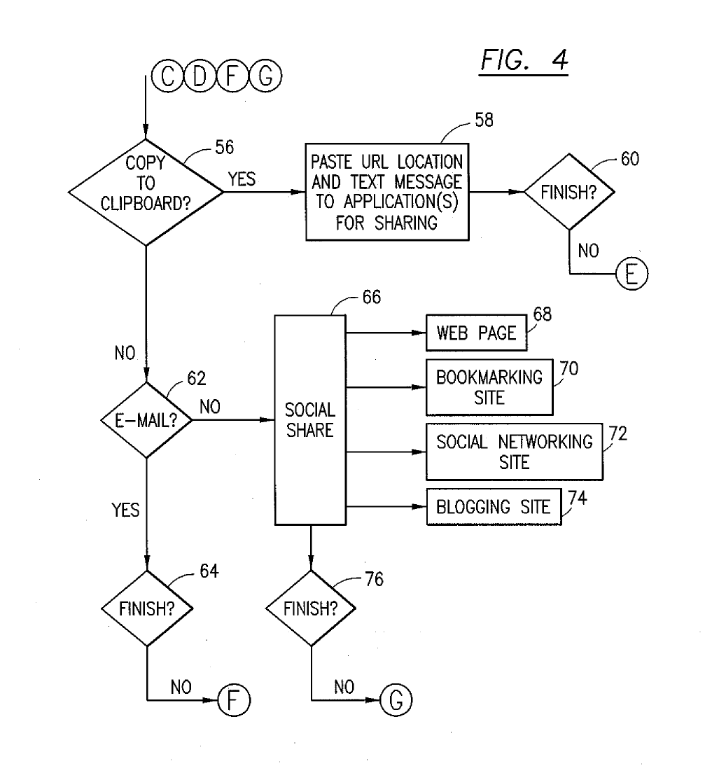

As noted above in connection with a discussion of FIG. 2, the user may select one or more privacy settings for the files that he or she has selected or created that comprise the publication on the web page of the web server 12. See boxes 30 and 40. It should be understood that privacy settings may be selected at the time a file is created, or when one or more files are selected, or when the user is given the opportunity to edit the text message (box 52), or at essentially any other time during the process of this invention prior to clicking on a “finish” button as described below in connection with a discussion of FIG. 4. A screen is provided on the software application of this invention presenting the user with privacy setting buttons identified as private, direct or public. A “private” privacy setting allows only the user to have access to the publication which has been uploaded to the web server 12. A “direct” privacy setting means that only those third parties with whom the user has shared the URL location and text message may have access to the publication, plus any others that those third parties share it with. The term “third parties” in this context may include individuals or groups. A “public” privacy setting is one in which anyone may see the publication and associated text message, such as on a web site, a social networking site etc. The user may change a privacy setting, once selected, at any time.

Referring now to FIG. 4, the method steps of this invention for sharing of the URL location and associated text message with third parties is schematically illustrated. When the URL location and text message have been received by the client software, it populates a message box on the client device 14. As represented by box 56 in FIG. 4, the user is given the option in the message box to copy the URL location and text message, edited or unedited, to the clipboard of the client device 14. The device clipboard may then be employed to paste the URL location and text message to any application or service supported by the client device 14 capable of transmitting same via the internet for access by third party devices, such as e-mail, social networking sites etc. See box 58. The user is then given the option to click on a “finish” button, represented by box 60 in FIG. 4, or repeat the process of creating a new file or selecting existing file(s) beginning at box 24 in FIG. 2. In the event the user chooses to add one or more files to the publication on the web server, the process discussed with reference to FIG. 2 may be substantially repeated. Any newly created files or additional existing files intended for publication on the web server 12 are uploaded to the same URL location as the initially uploaded file(s).

The software application on the client device 14 provides other options for sharing the URL location and text message with third parties besides copy to clipboard. As represented by box 62 in FIG. 4, the user may e-mail the URL location and text message to third party devices prior to clicking on a finish button depicted by box 64. Alternatively, as schematically represented by boxes 66-74 in FIG. 4, the URL location and text message may shared via one or more public or social networking solutions (box 66) such as a web page (box 68), bookmarking site (box 70), social networking site (box 72), blogging site (box 74) and others. After transmitting the URL location and text message to any of the options denoted in boxes 68-74 (or other options), and prior to clicking on a finish button depicted by box 76, the user may return to the message box and copy the URL location and text message to the device clipboard. See box 56. Further, the user may substantially repeat the process of creating a new file or selecting existing file(s) beginning at box 24 in FIG. 2 and proceeding as described above, prior to clicking on either of the finish buttons 64 or 76. As noted above, any newly created files or additional existing files for publication to the web server 12 are uploaded to the same URL location as the initially uploaded file(s).

The discussion above with reference to FIG. 4 related to returning to box 24 prior to clicking on “finish” buttons 60, 64 or 76 should not be construed to require actuation of a “save and continue” button 32 or 42 as schematically depicted in FIG. 2. In fact, provided the client device 14 remains connected to the internet, most of the tasks that can be undertaken on the software application may be performed “on the fly,” e.g. in real time, and at any time following the commencement of background uploading of the initial file(s) to the web server 12 as represented by box 44. Specifically, the user is free to change or delete privacy settings, to create, modify or delete a description of the publication on the web server 12 resulting from the upload of one or more files thereto, and/or to create, change or delete the text message that may accompany the URL location for the publication, all “on the fly” in real time, and all while the initially uploaded file(s) or newly created or selected files are uploading in the background. Consequently, as a user types a new publication description or a new text message on his or her client device 14, or changes to ones previously published, for example, such new material or modifications are substantially instantaneously transmitted to the publication displayed on the web server 12 where they appear on the web page virtually in real time.

The method and process of this invention is highly efficient and much less time consuming compared to prior art methods of file sharing or file publishing via the internet. Background uploading of one or more files from the software application on the client device 14 to the web server 12 can take place at the same time that the user: (i) shares the location of such files with others, (ii) creates new files or selects existing ones for publication at the same URL location as the initially uploaded file(s), (iii) edits privacy settings, (iv) edits the text message, (v) modifies the description of uploaded files, or, (vi) proceeds with other tasks on the client device 14 unrelated to such publication. There is no more waiting for the entire file sharing process to be completed before another task can be undertaken, as in many prior art systems.

While the invention has been described with reference to a preferred embodiment, it should be understood by those skilled in the art that various changes may be made and equivalents substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A method of publishing and sharing files via the internet, comprising:
(a) providing a software application on a client device;
(b) providing a web server;
(c) creating a file using the software application on the client device and/or selecting one or more existing files stored on the client device;
(d) background uploading at least one file created or selected as a result of step (c) from the software application to the web server via the internet, the web server creating a URL location for the destination of the at least one file and a web page to display the at least one file;
(e) transmitting the URL location from the web server to the software application on the client device;
(f) transmitting the URL location from the software application on the client device in such a way as to provide access by one or more third party devices to the web page on the web server;
(g) performing steps (e) and/or (f) while step (d) is proceeding in the background.

2. The method of claim 1 in which step (c) includes creating an audio file, a video file, a photograph, a text file, a data file or any combination thereof.

3. The method of claim 1 in which step (c) includes selecting one or more existing files stored on the client device including an audio file, a video file, a photograph, a text file, a data file or any combination thereof.

4. The method of claim 1 in which step (d) includes the creation of a text message by the web server which is associated with the URL location.

5. The method of claim 4 further including the step of modifying the text message associated with the URL location that was created by the web server in step (d).

6. The method of claim 5 further including the step of selecting a privacy option for the at least one file.

7. The method of claim 6 further including the step of creating a description of the at least one file on the web page of the web server.

8. The method of claim 7 in which the steps of creating a description of the at least one file, selecting a privacy option and/or modifying the text message associated with the URL location may be performed in real time and at any time following the initiation of step (e).

9. The method of claim 1 in which step (f) includes copying the URL location to a clipboard of the client device, and then pasting the URL location into at least one service or application on the client device that permits transmission of the URL location from the client device via the internet for access by one or more third party devices.

10. The method of claim 1 in which step (f) includes transmitting the URL location from the client device to one or more third party devices via e-mail.

11. The method of claim 1 in which step (f) includes transmitting the URL location from the client device to one or more web sites, bookmarking sites, social networking sites or blogging sites that may be accessed by third party devices.

12. The method of publishing and sharing files via the internet, comprising:
(a) providing a software application on a client device;
(b) providing a web server;
(c) selecting a first file comprising a file created using the software application on the client device or one or more existing files stored on the client device;
(d) background uploading the first file from the software application to the web server via the internet, the web server creating a URL location for the destination of the first file, a text message associated with the URL location and a web page to display the first file;
(e) transmitting the URL location and text message from the web server to the software application on the client device;
(f) transmitting the URL location and text message from the software application on the client device in such a way as to provide access by one or more third party devices to the web page on the web server;
(g) selecting a second file comprising a second file created using the software application on the client device or one or more existing second files stored on the client device;
(h) background uploading the second file from the software application of the client device to the web server, the second file being background uploaded to the same destination as the first file;
(i) performing steps (e), (f) and (g) while step (d) and/or step (h) are proceeding in the background.

13. The method of claim 12 further including the step of modifying the text message received by the software application on the client device from the web server in real time and at any time following the initiation of step (e).

14. The method of claim 12 further including the step of uploading modifications of the first file and/or the second file in real time and at any time following the initiation of step (e).

15. The method of claim 12 further including the step of creating a description of a publication on the web page of the web server, the publication comprising a compilation of the first file and the second file.

16. The method of claim 15 in which the step of creating a description of the publication further includes modifying the description in real time and at any time following the initiation of step (e).

17. The method of claim 12 in which step (c) and/or step (g) includes creating an audio file, a video file, a photograph, a text file, a data file or any combination thereof.

18. The method of claim 12 in which step (c) and/or step (g) includes selecting one or more existing files stored on the client device including an audio file, a video file, a photograph, a text file, a data file or any combination thereof.

19. The method of claim 12 in which step (f) includes copying the URL location and text message to a clipboard of the client device, and then pasting the URL location and text message into at least one service or application on the client device that permits transmission of the URL location and text message from the client device via the internet for access by one or more third party devices.

20. The method of claim 12 in which step (f) includes transmitting the URL location and text message from the client device to one or more third party devices via e-mail.

21. The method of claim 12 in which step (f) includes transmitting the URL location and text message from the client device to one or more web sites, bookmarking sites, social networking sites or blogging sites that may be accessed by third party devices.

22. The method of claim 12 further including the step of selecting a privacy option for the first file and for the second file.

23. The method of publishing and sharing files via the internet, comprising:
(a) providing a software application on a client device;
(b) providing a web server;
(c) selecting a first file comprising a file created using the software application on the client device or one or more existing files stored on the client device;
(d) background uploading the first file from the software application to the web server via the internet, the web server creating a URL location for the destination of the first file, a text message associated with the URL location and a web page on which the first file is displayed as a publication;
(e) transmitting the URL location and text message from the web server to the software application on the client device;
(f) transmitting the URL location and text message from the software application on the client device in such a way as to provide access by one or more third party devices to the web page on the web server;
(g) selecting a second file comprising a second file created using the software application on the client device or one or existing second files stored on the client device;
(h) background uploading the second file from the software application of the client device to the web server, the second file being background uploaded to the same destination as the first file forming a part of the publication;
(i) creating a description of the publication;
(j) selecting a privacy setting for the publication;
(k) modifying the text message, description of the publication and/or the privacy setting for the publication in real time and at any time following the initiation of step (e); and
(l) performing steps (e), (f), (g), (i), (j) and/or (k) while step (d) and/or step (h) are proceeding in the background.

24. The method of claim 23 in which step (c) and/or step (g) includes creating an audio file, a video file, a photograph, a text file, a data file or any combination thereof.

25. The method of claim 23 in which step (c) and/or step (g) includes selecting one or more existing files stored on the client device including an audio file, a video file, a photograph, a text file, a data file or any combination thereof.

26. The method of claim 23 in which step (f) includes copying the URL location and text message to a clipboard of the client device, and then pasting the URL location and text message into at least one service or application on the client device that permits transmission of the URL location and text message from the client device via the internet for access by one or more third party devices.

27. The method of claim 23 in which step (f) includes transmitting the URL location and text message from the client device to one or more third party devices via e-mail.

28. The method of claim 23 in which step (f) includes transmitting the URL location and text message to one or more web sites, bookmarking sites, social networking sites or blogging sites that may be accessed by third party devices.
